(19) United States
(12) Patent Application Publication
(10) Pub. No.: US 2010/0125873 A1
(43) Pub. Date: May 20, 2010

(54) Event-calendar display apparatus, event-calendar display method, event-calendar display program, and event-information extraction apparatus

(75) Inventors: Daisuke Yano, Kanagawa (JP); Naoki Fujisawa, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/589,629

(22) Filed: Oct. 26, 2009

(30) Foreign Application Priority Data
Nov. 20, 2008 (JP) 2008-297006

(51) Int. Cl. H04N 5/445

(52) U.S. Cl. 725/37

(57) ABSTRACT

An event-calendar display apparatus includes: a content acquisition section acquiring a television program; an event-information extraction section analyzing the television program acquired by the content acquisition section and extracting event information from the television program; a storage control section storing the event information extracted by the event-information extraction section into a storage section; and a display control section displaying the event information stored on the storage section in a display section in a calendar format.

### CROSS-REFERENCE TO RELATED APPLICATION

The present application claims priority from Japanese Patent Application JP 2008-297006 filed in the Japanese Patent Office on Nov. 20, 2008, the entire content of which is hereby incorporated by reference.

### BACKGROUND OF THE INVENTION

1. Field of the Invention

The present invention relates to an event-calendar display apparatus, an event-calendar display method, an event-calendar display program, and an event-information extraction apparatus. For example, the present invention is suitably applied to an apparatus displaying an event calendar including a description of various kinds of events.

2. Description of the Related Art

In recent years, a large number of information processing apparatuses, such as a personal computer (also called a “PC”), a PDA (Personal Digital Assistance), a cellular phone, etc., have a function of displaying a calendar (this is also called a “calendar display function”)(for example, refer to Japanese Unexamined Patent Application Publication No. 2000-163209).

Also, there are information processing apparatuses having not only a function of simply displaying a calendar showing a date and a day of week, but a function of displaying an event calendar showing various kinds of event information.

Furthermore, there are online calendar systems in which such an event calendar is published on a homepage on the Internet to be provided to users. In such an online calendar system, access is gained from a PC or a cellular phone to a homepage of an event calendar so that the event calendar is displayed on a display section of the PC or the cellular phone.

### SUMMARY OF THE INVENTION

In an information processing apparatus having a function of displaying an event calendar, it is necessary for a user to input event information to be described on a calendar (this is also called “event information”). This is the same in the case of an online calendar system.

Also, there are online calendar systems in which an event calendar is shared among a plurality of users. In this case, it is also necessary at least for one user to input event information after all.

In this manner, in an information processing apparatus and online calendar system, which have a function of displaying an event calendar, it has been necessary for a user himself/herself to input event information to be described on the event calendar.

Here, it is thought that if a user can omit inputting event information by himself/herself, the user-friendliness of an event calendar is improved further.

The present invention has been made in view of the above points. It is desirable to propose an event-calendar display apparatus, an event-calendar display method, an event-calendar display program, and an event-information extraction apparatus which have more improved user-friendliness of an event calendar compared with related-art apparatuses, etc.

According to an embodiment of the present invention, there is provided an event-calendar display apparatus including: a content acquisition section acquiring a television program; an event-information extraction section analyzing the television program acquired by the content acquisition section and extracting event information from the television program; a storage control section storing the event information extracted by the event-information extraction section into a storage section; and a display control section displaying the event information stored in the storage section on a display section in a calendar format.

According to another embodiment of the present invention, there is provided an event information extraction apparatus including: a content acquisition section acquiring a television program; an event-information extraction section analyzing the television program acquired by the content acquisition section and extracting event information from the television program; a storage control section storing the event information extracted by the event-information extraction section into a storage section; and a transmission section transmitting the event information stored in the storage section to a display apparatus displaying in a calendar format.

In this manner, a television program is analyzed, and event information is automatically extracted from the television program so that it is possible to present an event calendar showing event information to a user without the user inputting the event information by himself/herself.

By the present invention, a television program is analyzed, and event information is automatically extracted from the television program so that it is possible to present an event calendar showing event information to a user without the user inputting the event information by himself/herself. Thus, by the present invention, it is possible to achieve an event-calendar display apparatus, an event-calendar display method, an event-calendar display program, and an event-information extraction apparatus which have more improved user-friendliness of an event calendar compared with related-art apparatuses, etc.

### BRIEF DESCRIPTION OF THE DRAWINGS

FIG. 1 is a schematic diagram illustrating a configuration of an event-calendar display system;

FIG. 2 is a block diagram illustrating an internal configuration of a television receiver;

FIG. 3 is a schematic diagram used for explaining finding of character information from a program video;

FIG. 4 is a schematic diagram used for explaining extraction of event information from character information;

FIG. 5 is a schematic diagram used for explaining registration of a preference keyword;

FIG. 6 is a schematic diagram illustrating a configuration (1) of an event-calendar screen;

FIG. 7 is a schematic diagram illustrating a configuration (2) of an event-calendar screen;

FIG. 8 is a flowchart illustrating a procedure of event-information extraction processing;

FIG. 9 is a flowchart illustrating a procedure of event-calendar display processing;

FIG. 10 is a flowchart illustrating a procedure of event-extraction processing in a second embodiment;

FIG. 11 is a schematic diagram illustrating a configuration (1) of an event-calendar display system in another embodiment;

FIG. 12 is a schematic illustrating a configuration (2) of an event-calendar display system in another embodiment; and

FIG. 13 is a schematic diagram illustrating a configuration of an event-calendar screen in another embodiment.

### DESCRIPTION OF THE PREFERRED EMBODIMENTS

In the following, a detailed description will be given of an embodiment of the present invention with reference to the drawings.
1. First embodiment
2. Second embodiment
3. Other embodiments

### 1. First Embodiment

First, a description will be given of a first embodiment.

### 1.1 Configuration of Event-calendar Display System

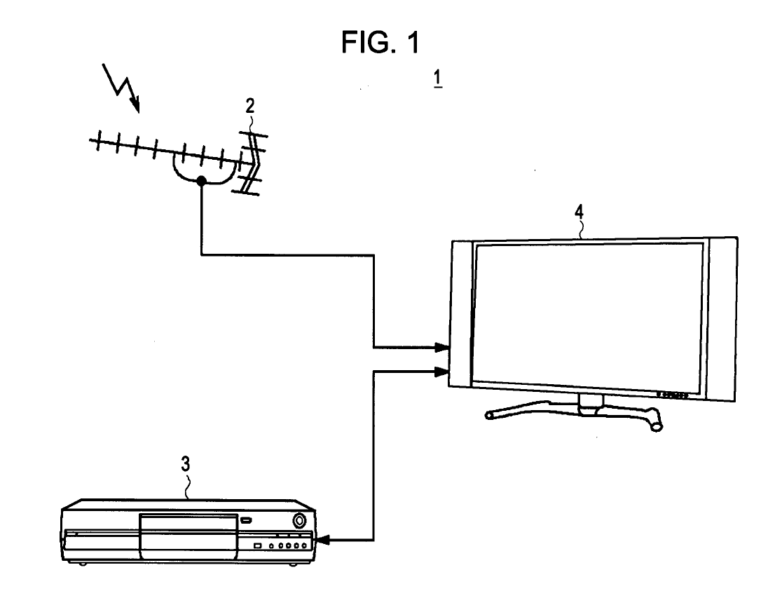

In FIG. 1, reference numeral 1 denotes an event-calendar display system. The event-calendar display system 1 has a television receiver 4 which plays back and outputs a broadcast content received from a broadcasting station (not shown in the figure) through an antenna 2, or a broadcast content recorded in a recording apparatus 3.

The television receiver 4 automatically extracts various kinds of event information from the broadcast content, and displays the extracted event information in a calendar format (that is to say, as an event calendar).

In this regard, a broadcast content (television program content) mentioned here includes video and audio of a program, subtitles, an electronic program guide, data broadcasting, etc. This includes a large amount of event information, such as program advertisement information, movie advertisement information, sale date of goods, campaign information of goods, sales information of stores, etc.

Also, the broadcast content includes not only a content provided to the television receiver 4 through broadcast waves, but also includes a content provided through a cable or the Internet.

### 1.2 Configuration of Television Receiver

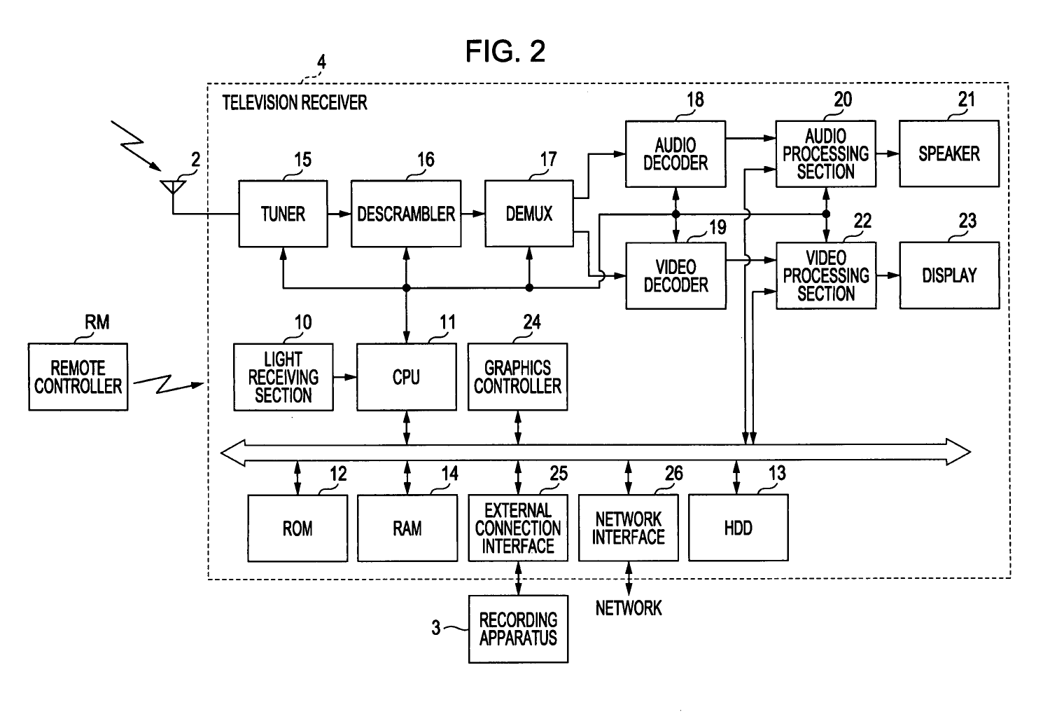

Next, a description will be given of a configuration of a television receiver 4 using FIG. 2. The television receiver 4 receives an infrared signal from a remote controller (this is also called a “remote control”) RM at a light receiving section 10. The light receiving section 10 obtains an operation signal corresponding to a user's operation from the received infrared signal, and sends this signal to the CPU (Central Processing Unit) 11.

The CPU 11 loads a program written in a ROM (Read Only Memory) 12 or an HDD (Hard Disk Drive) 13 into a RAM (Random Access Memory) 14. The CPU 11 performs the program loaded in the RAM 14 in accordance with an operation signal sent from the light receiving section 10 so as to perform overall control to achieve various functions. In this regard, the HDD 13 may be replaced by a nonvolatile memory, such as a flash memory, etc.

Specifically, in the television receiver 4, a television broadcast signal sent through an antenna 2 is input into the tuner 15. The tuner 15 obtains a transport stream of the channel specified by, for example, by an operation of the remote controller RM under the control of the CPU 11, and sends the stream to a descrambler 16.

Under the control of the CPU 11, the descrambler 16 obtains a key for releasing the scramble of the transport stream from an IC card (not shown in the figure) loaded the television receiver 4, and descramles the transport stream using the key. The descrambled transport stream is sent to a DEMUX (demultiplexer) 17.

Under the control of the CPU 11, the DEMUX 17 extracts video data and audio data from the descrambled transport stream and sends the audio data to the audio decoder 18, and sends the video data to the video decoder 19.

Under the control of the CPU 11, the audio decoder decodes the sent audio data obtains an audio signal, and sends the signal to an audio processing section 20. The audio processing section 20 performs predetermined audio processing on the audio signal under the control of the CPU 11, and sends the signal to the speaker 21. As a result, the speaker 21 outputs sound of the program being broadcast.

On the other hand, the video decoder 19 decodes the sent video data to obtain a video signal, and sends the signal to the video processing section 22 under the control of the CPU 11. The video processing section 22 performs predetermined video processing on the video signal, and sends the signal to the display 23 under the control of the CPU 11. As a result, the video of the program being broadcast is displayed on the display 23.

In this manner, the television receiver 4 allows a user to view the program being broadcast.

Also, the DEMUX 17 of the television receiver 4 extracts EPG (Electronic Program Guide) data, which is electronic program guide data, from the descrambled transport stream under the control of the CPU 11, and sends the data to the CPU 11. In this regard, the EPG data includes a broadcasting station name, a channel number, broadcasting date and time, a program name, a genre, a program summary, program details, etc., as information for each program to be broadcast (this is also called a “program information”).

The CPU 11 stores the EPG data into the HDD 13 or the RAM 14, and then reads the data from these, and sends the data to a graphics controller 24. The graphics controller 24 generates a screen signal of a program guide screen on the basis of the EPG data, and sends the signal to the video processing section 22.

The video processing section 22 performs predetermined video processing on the screen signal under the control of the CPU 11, and sends the signal to the display 23. As a result, the program guide screen is displayed on the display 23.

In this manner, the television receiver 4 presents the program guide screen to a user.

Further, the DEMUX 17 of the television receiver 4 extracts data constituting a screen (this is also called a data broadcast screen) of data broadcast from the descrambled transport stream under the control of the CPU 11, and sends the data to the CPU 11. In this regard, the data constituting the data broadcast screen is text data, still image data, etc. The CPU 11 sends the data to the graphics controller 24. The graphics controller 24 generates a screen signal of the data broadcast screen on the basis of this data, and sends the signal to the video processing section 22.

The video processing section 22 performs predetermined video processing on the screen signal under the control of the CPU 11, and sends the signal to the display 23. As a result, the data broadcast screen is displayed on the display 23.

In this manner, the television receiver 4 presents the data broadcast screen to the user.

Further, the DEMUX 17 of the television receiver 4 extracts subtitle data (text data of subtitles) from the descrambled transport stream under the control of the CPU 11, and sends the data to the CPU 11. The CPU 11 stores the subtitle data into the HDD 13 or the RAM 14, and then reads the data from these, and sends the data to the graphics controller 24. The graphics controller 24 generates an image signal of the subtitle on the basis of the subtitle data, and sends the signal to the video processing section 22.

The video processing section 22 combines the video signal sent from the video decoder 19 and the image signal of the subtitles sent from the graphics controller 24 under the control of the CPU 11, perform predetermined video processing, and sends the signal to the display 23. As a result, the video of the program with the subtitles is displayed on the display 23.

In this manner, the television receiver 4 allows the user to view the program with the subtitles.

Further, the television receiver 4 is externally connected to a recording apparatus 3 through an external connection interface 25, such as an HDMI (High Definition Multimedia Interface), etc. And the television receiver 4 inputs an audio signal of the recorded program being sent from the recording apparatus 3 into the audio processing section 20, and also inputs the video signal into the video processing section 22.

The audio processing section 20 performs predetermined audio processing on the audio signal of the recorded program, and sends the signal to the speaker 21. As a result, the speaker 21 outputs sound of the recorded program.

On the other hand, the video processing section 22 performs predetermined video processing on the video signal of the recorded program, and sends the signal to the display 23. As a result, the video of the recorded program is displayed on the display 23.

In this manner, the television receiver 4 allows the user to view the program recorded in the recording apparatus 3.

As described so far, the television receiver 4 is capable of providing a program being broadcast, a program with subtitles, a recorded program, a program guide, and data broadcast.

Further, the television receiver 4 is connected to a network, such as the Internet, etc., through a network interface 26, and is capable of transmitting and receiving various kinds of data between a server (not shown in the figure) on the network.

Specifically, the CPU 11 of the television receiver accesses, for example, a server on which a home page is established, and receives page data for displaying a home page screen (this is also called a “home page screen”) from the server.

And the CPU 11 sends the page data to the graphics controller 24. The graphics controller 24 generates a screen signal of the home page on the basis of the page data, and sends the signal to the video processing section 22.

The video processing section 22 performs predetermined video processing on the screen signal under the control of the CPU 11, and sends the signal to the display 23. As a result, the home page screen is displayed on the display 23.

In addition, the television receiver 4 has a function of extracting event information from a broadcast content (program video sound, subtitles, an electronic program guide, data broadcast, etc.), and of displaying an event calendar on which the event information is described. In the following, a detailed description will be given of displaying the event calendar.

### 1.3 Event Calendar Display

The television receiver 4 finds character information from the broadcast content, and further extracts event information from the character information. In this regard, the event information is assumed to be information indicating at least when and what (what event) will be held. Accordingly, the event information includes at least event date and time (this is also called “event date and time”) and a title (this is also called an “event title”).

For example, it is assumed that the television receiver 4 plays back and outputs a program being broadcast to allow a user to view the program. During this period, the CPU 11 of the television receiver 4 controls the video processing section 22 and the audio processing section 20 to find a character string from the video sound of the program being broadcast.

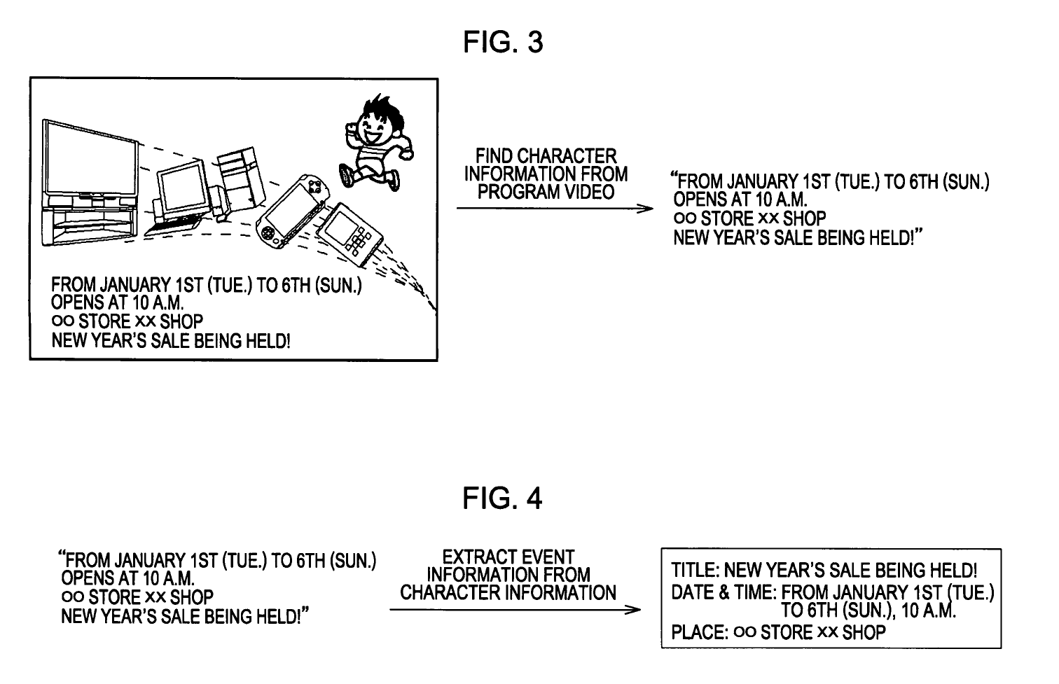

Specifically, the video processing section 22 performs predetermined video processing on the video signal sent from the video decoder 19, and finds character strings included in the video of the program being broadcast using a predetermined character-recognition algorithm on the basis of the video signal as shown in FIG. 3. In this regard, on character-recognition algorithms for finding character strings (that is to say, the character strings displayed as a part of the video) included in the video, a large number of methods have been already widespread. Thus, the detailed description thereof will be omitted here.

And the video processing section 22 sends the character information indicating the found character string to the CPU 11. The CPU 11 stores the character information into the HDD 13 or the RAM 14 as character information obtained from the video of the program being broadcast.

On the other hand, the audio processing section 20 performs predetermined audio processing on the audio signal sent from the audio decoder 18 under the control of the CPU 11, and converts sound of the program being broadcast into character strings using a predetermined sound-to-character conversion algorithm on the basis of the audio signal. In this regard, on sound-to-character conversion algorithms, a large number of methods have been already widespread. Thus, the detailed description thereof will be omitted here.

And the audio processing section 20 sends character information indicating the converted character string to the CPU 11. The CPU 11 stores the character information into the HDD 13 or the RAM 14 as the character information obtained from the sound of the program being broadcast.

Also, in the case where the television receiver 4 plays back and outputs the recorded program to allow a user to view the program, the television receiver 4 finds character strings from the video sound of the recorded program in the same manner as the case of finding character strings from the video sound of the program being broadcast.

At this time, the CPU 11 stores the character information being sent from the video processing section 22 into the HDD 13 or the RAM 14 as the character information obtained from the video of the recorded program. Also, at this time, the CPU 11 stores the character information being sent from the audio processing section 20 into the HDD 13 or the RAM 14 as the character information obtained from the sound of the recorded program.

In this manner, the character information including the character strings found from the video sound of the program being broadcast and the video sound of the recorded program is stored into the HDD 13 or the RAM 14.

Further, when the CPU 11 obtains the EPG data through the DEMUX 17 as described above, the CPU 11 stores, for example, the program summary and the program details included in the EPG data into the HDD 13 or the RAM 14 as the character information obtained from the electronic program guide.

In this manner, the character information obtained from the electronic program guide is stored into the HDD 13 or the RAM 14.

Further, when the CPU 11 obtains data constituting the data broadcast screen through the DEMUX 17 as described above, the CPU 11 stores text data of this data into the HDD or the RAM 14 as the character information obtained from the data broadcast.

In this manner, the character information obtained from the data broadcast is stored into the HDD 13 or the RAM 14.

Further, when the CPU 11 obtains subtitle data through the DEMUX 17 as described above, the CPU 11 stores the subtitle data into the HDD 13 or the RAM 14 as the character information obtained from the subtitle.

In this manner, the character information obtained from the subtitles into the HDD 13 or the RAM 14.

And the CPU 11 extracts event information from the character information stored in the HDD 13 or the RAM 14, namely, from the character information found from the broadcast content. A description is given of an extraction method of specific event information here.

As described above, the event information is information indicating at least event date and time, and an event title. Accordingly, in order to extract event information from the character information, it is necessary to find event date and time, and an event title in the character information.

Then CPU 11, first, finds a character string (for example, “April 1st”, “every Monday”, “10 o'clock every morning”, etc.) indicating event date and time.

In this regard, dictionary data including rules for identifying a character string indicating event date and time (for example, “*month*day”, “every week*day of week”, “every morning*time”, etc.) is stored in advance in the ROM 12 or the HDD 13. That is to say, the CPU 11 searches for a character string indicating event date and time from the character information using the dictionary data.

If the CPU 11 finds a character string indicating event date and time, the CPU 11 searches for words and phrases indicating the event title next. Here, it can be assumed that the words and phrases indicating an event title are located near the character string indicating event date and time. In this regard, the words and phrases mentioned here mean a group of character strings including one word or more.

Then the CPU 11 extracts a predetermined range of character strings before and after the character string indicating the event date and time from the character information, and stores this into the RAM 14. Further, the CPU 11 divides the extracted character string into words using a natural language processing technique, and stores the words into the RAM 14. In this regard, for a natural language processing technique dividing a character string into words, many methods, such as morphological analysis, etc., are already widespread. Accordingly, the description thereof will be omitted here.

And the CPU 11 searches the words for a word that is frequently used as a part of an event title (for example, “broadcasting”, “publish”, “release”, “campaign”, “sale”, etc.).

In this regard, a word that is frequently used as a part of an event title is also stored in the above-described dictionary data in advance. That is to say, the CPU 11 searches for a word that is frequently used as a part of an event title using this dictionary data.

When the CPU 11 finds a word that is frequently used as a part of an event title, the CPU 11 determines the words and phrases including the word as an event title.

In this manner, the CPU 11 searches for event date and time, and an event title from the character information.

Also, the CPU 11 searches not only for event date and time, and an event title, but also an event place, a telephone number, a URL (Uniform Resource Locator), etc.

For example, when the CPU 11 searches for an event place from the character information, the CPU 11 searches the words obtained by dividing a predetermined range of character strings before and after the character string indicating event date and time, for a word indicating an event place.

In this regard, words indicating event places are also registered in the above-described dictionary data in advance. That is to say, the CPU 11 searches words indicating an event place using this dictionary data.

Also, when the CPU 11 searches the character information for a telephone number of an event, the CPU 11 searches a predetermined range of character strings before and after the character string indicating event date and time, for a character string indicating a telephone number.

In this regard, the above-described dictionary data also includes rules for identifying a character string indicating a telephone number (for example, “**-****-****”, etc.) in advance. That is to say, the CPU 11 searches for a character string indicating a telephone number using this dictionary data.

Further, when the CPU 11 searches character information for a URL of an event, the CPU 11 searches a predetermined range of character strings before and after the character string indicating the event date and time for a character string indicating a URL.

In this regard, the above-described dictionary data also includes rules for identifying a URL (for example, “http://***”, etc.). That is to say, the CPU 11 searches for a character string indicating a URL using the dictionary data.

In this manner, the CPU 11 searches for an event place, a telephone number, and a URL, etc., from the character information.

In this manner, the CPU 11 searches for date and time of an event from the character information first, and then searches for the title, the place, the telephone number, the URL, etc., of the event. When the CPU 11 finds these, the CPU 11 extracts these from the character information as event information.

Here, an example of event information extracted from character information is shown in FIG. 4. The event information necessarily includes event date and time, and a title. Further, the event information includes the items found (only a place in the example in FIG. 4) out of the place, the telephone number, the URL, etc., of the event.

Further, the CPU 11 selects only the event information matching a user's preference out of the extracted event information, and stores the information into the event database built in the HDD 13 in advance.

In this regard, a preference database is built in the HDD 13 in advance, and preference keywords are stored in the preference database as preference information indicating a user's preference at any time. And the CPU 11 selects the event information including the preference keywords as the event information matching the user's preference.

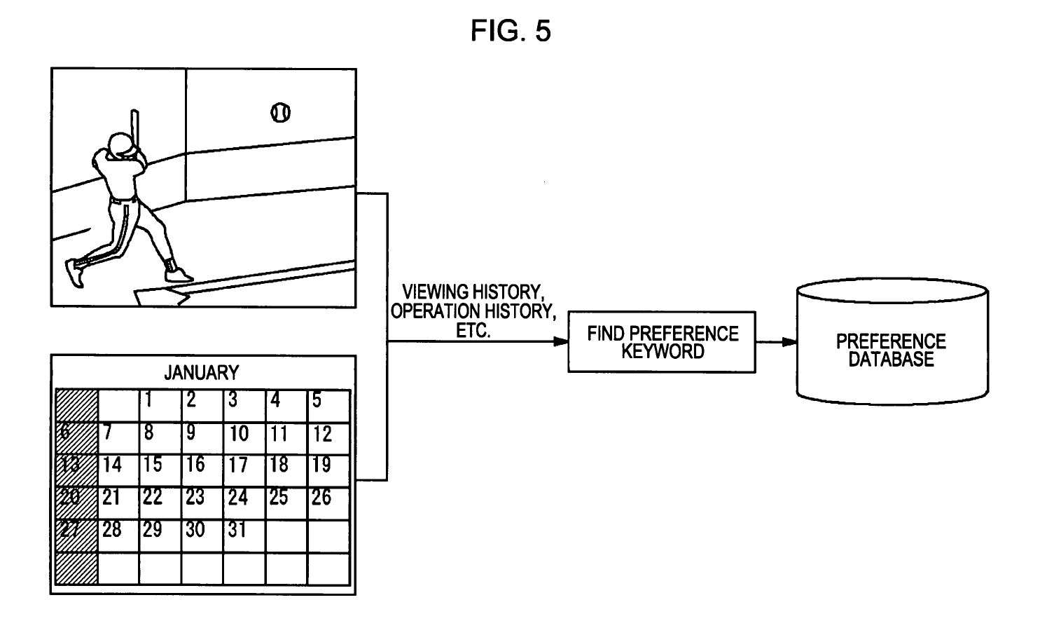

Incidentally, as shown in FIG. 5, the preference keywords are automatically stored in the preference database by the CPU 11 on the basis of a viewing history of programs and operation histories on various kinds of screens. That is to say, the CPU 11 stores, for example, genres of programs frequently viewed by a user, the titles of events, etc., the user has selected on an event calendar screen described later as preference keywords.

Thus, only event information matching the user's preference is stored in the event database out of the event information extracted from the character information.

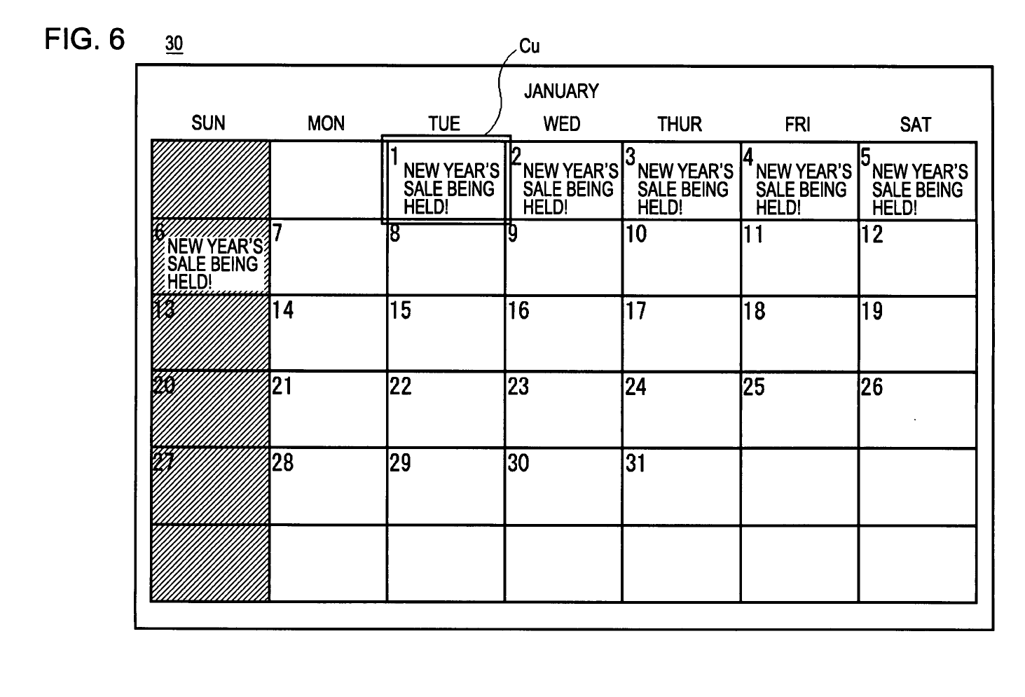

And when, for example, an instruction to display an event calendar screen is given to the CPU 11 through the remote controller RM, an event calendar screen 30 as shown in FIG. 6 is displayed on the display 23 on the basis of the event information stored in the event database.

Specifically, the CPU 11 first displays the event calendar of this month (January in the example in FIG. 6) on the event calendar screen 30. The CPU 11 changes event calendars to the next month calendar or the previous month calendar in sequence in response to an operation through the remote controller RM.

Here, the event calendar includes 6 pieces of boxes vertically×7 pieces of boxes horizontally, and thus 42 pieces of boxes in total. The horizontal 7 pieces of boxes correspond to individual days of a week, from left, Sunday, Monday, Tuesday, Wednesday, Thursday, Friday, and Saturday.

And the CPU 11 displays a number indicating each day in each box of the event calendar in accordance with a day of a week of one day and the number of days in the specified month.

Further, the CPU 11 reads event information of which event date and time falls within the specified month from the event database, and displays the event title included in the event information in the box corresponding to the event date and time included in the event information.

In this manner, the television receiver 4 allows the user to check when and what (what event) will be held at a glance through the event calendar display screen 30.

Also, the event calendar display screen 30 can change displays from a monthly display to a weekly display (not shown in the figure), or a daily display (not shown in the figure) in response to an operation through the remote controller RM.

Further, a cursor Cu allowing the user to select any box (that is to say, a day) in response to, for example, an operation of a direction key of the remote controller RM is displayed on the event calendar screen 30.

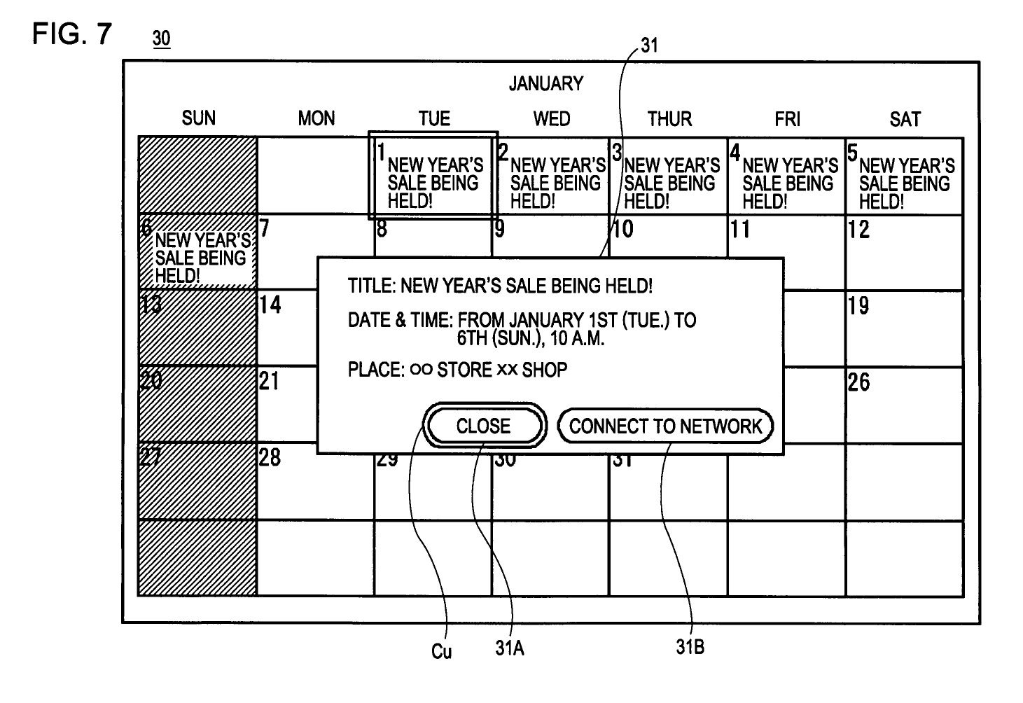

In a state in which a box (that is to say, a day on which an event will be held) displaying an event title is selected by the cursor Cu, if a determination key of the remote controller RM is pressed for example, the CPU 11 displays an event detail window 31 as shown in FIG. 7.

The event information of the event to be held on a selected day is displayed in the event detail window 31. That is to say, on the event detail window 31, event date and time, and a title to be held on that day, a place, a telephone number, a URL, etc., are displayed.

By displaying such an event detail window 31, the television receiver 4 allows the user to check detailed information on an event selected from the event calendar screen 30.

Further, a close button 31A and a connect-to-network button 31B are displayed on the event detail window 31. The close button 31A and the connect-to-network button 31B can also be selected by the cursor Cu.

In a state of the close button 31A being selected by the cursor Cu, for example, if the determination key of the remote controller RM is pressed, the CPU 11 closes the event detail window 31. Also, in a state of the connect-to-network button 31B being selected, for example, if the determination key of the remote controller RM is pressed, the CPU 11 connects to the network, receives various kinds of information on the event information displayed in the event detail window from the server on the network, and displays the information on the display 23.

For example, if the event information includes a URL, the CPU 11 accesses the server specified by the URL, and receives page data. And the CPU 11 displays a home page screen on the display 13 on the basis of the page data.

Also, if the event information includes a place, the CPU 11 accesses the server on which a map page is established, and receives the page data of the map page screen showing a map of the surrounding area of the place. And the CPU 11 displays the map page screen on the display 13 on the basis of the page data.

Further, the CPU 11 may access a server on which a good purchase page is established, for example, and may display a purchase page screen for purchasing goods on the event on the basis of the event title included in the event information on the display 13, etc.

Further, the CPU 11 may access a server on which a ticket reservation page is established, and may display a reservation page screen for reserving an event on the basis of the event title on the display 23, etc.

Further, the CPU 11 may access a server on which a coupon distribution page is established, and may display a coupon page screen for displaying a coupon on the event on the basis of the event title on the display 23, etc.

In this manner, the television receiver 4 can provide the user with various kinds of information on the event selected from the event-calendar display screen 30.

### 1.4 Processing Procedure

Next, a description will be given of a processing procedure from the extraction of event information to the display of an event calendar screen described above. Here, a description will be given separately of a processing procedure from the extraction of the event information to the registration in the event database, and a processing procedure to display an event calendar screen on the basis of the event information stored in the event database.

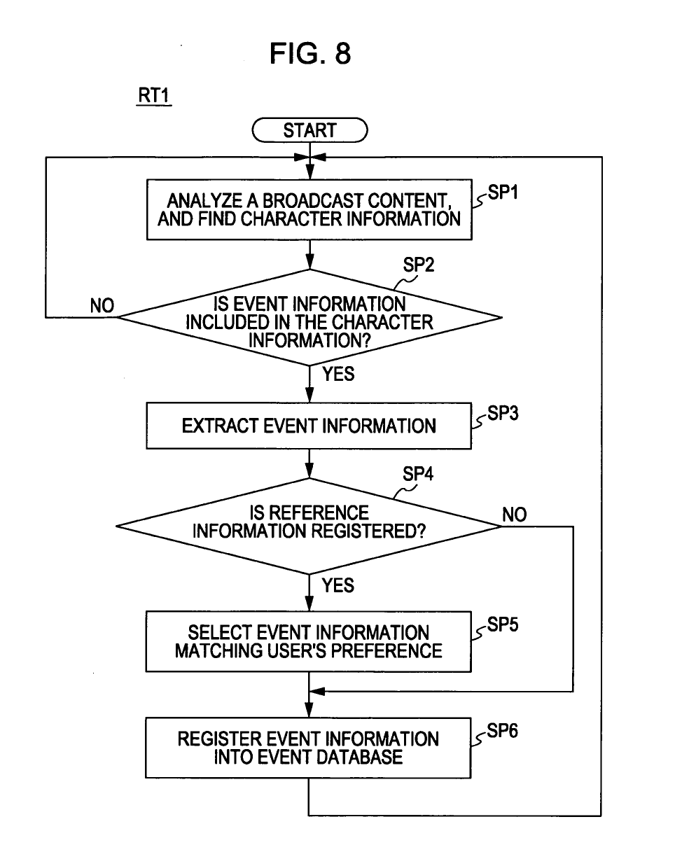

First, a description will be given of a processing procedure (this is also called an event-information extraction processing procedure) from the extraction of event information to the registration in an event database using the flowchart shown in FIG. 8. Incidentally, the processing procedure is a processing procedure executed by the CPU 11 of the television receiver 4 in accordance with the program written in the ROM 12 or the HDD 13.

When, for example, the power to the television receiver 4 is turned on, the CPU 11 starts an event-information extraction processing procedure RT1, and the processing proceeds to step SP1. In step SP1, the CPU 11 analyzes a broadcast content (program video sound, subtitles, an electronic program guide, data broadcasting, etc.) so as to find character information from the broadcast content, and the processing proceeds to the next step SP2.

In step SP2, the CPU 11 determines whether the found character information includes event information. Specifically, the CPU 11 determines whether the character information includes the event information by determining whether the character information includes a character string indicating event date and time.

If the character information does not include event information, and thus negative result is obtained by step SP2, the processing of the CPU 11 returns to step SP1, and continues to find character information.

On the other hand, if the character information includes event information, and thus affirmative result is obtained by step SP2, the processing of the CPU 11 proceeds to step SP3. In step SP3, the CPU 11 extracts event information from the character information, and the processing proceeds to the next step SP4.

In step SP4, the CPU 11 determines whether preference information (preference keywords) is stored in the preference database. If preference information is stored, and thus affirmative result is obtained by step SP4, the processing of the CPU 11 proceeds to step SP5.

In step SP5, the CPU 11 selects event information matching a user's preference out of the event information extracted in step SP3 on the basis of the preference information stored in the preference database, and the processing proceeds to the next step SP6.

On the other hand, if preference information is not stored, and a negative result is obtained in step SP4, the CPU skips step SP5, that is to say, selects the entire extracted event information, and the processing proceeds to step SP6.

In step SP6, the CPU 11 stores the selected event information in the event database, returns to step SP1 again, and continues to find character information.

In accordance with such event information extraction processing procedure RT1, the CPU 11 extracts event information from a broadcast content, and stores the event information in the event database.

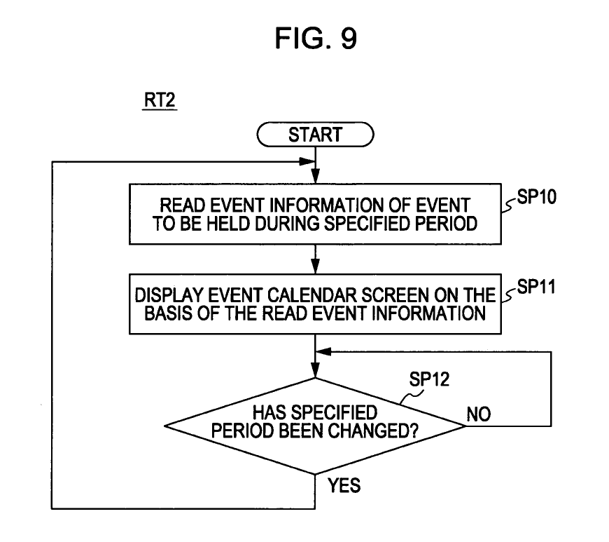

Next, a description will be given of a processing procedure (this is also called an event-calendar display processing procedure) displaying an event calendar screen 30 on the basis of the event information stored in the event database using a flowchart shown in FIG. 9. Incidentally, this processing procedure is also a processing procedure executed by the CPU 11 of the television receiver 4 in accordance with the program written in the ROM 12 or the HDD 13.

When the CPU 11 is instructed to display the event calendar screen 30 through the remote controller RM, the CPU 11 starts the event-calendar display processing procedure RT2, and proceeds to step SP10. In step SP10, the CPU 11 reads event information of the event to be held in a specified period (default is this month) from the event database, and the processing proceeds to the next step SP11.

In step SP11, the CPU 11 displays an event calendar screen 30 on the display 23 on the basis of the read event information, and the processing proceeds to the next step SP12.

In step SP12, the CPU 11 waits for an instruction of a change of specified periods through the remote controller RM. If an instruction to change specified periods is given, the processing returns to step SP10 again, and the CPU 11 reads the event information of the event to be held in the specified period after the change.

In accordance with such event-calendar display processing procedure RT2, the CPU 11 displays the event calendar screen 30 on the basis of the event information stored in the event database.

### 1.5 Operation and Effects in First Embodiment

In the above configuration, the television receiver analyzes the received broadcast content by a character recognition algorithm or sound-to-character conversion algorithm, etc., so that the television receiver 4 finds character information from the received broadcast content.

Further, the television receiver 4 extracts event information from the found character information, and stores the information into the event database.

In this manner, the television receiver 4 analyzes a broadcast content, and automatically extracts event information from the broadcast content, and stores the information.

And the television receiver 4 displays the stored event information in a calendar format, that is to say, as the event calendar screen 30.

In this manner, the television receiver 4 can present an event calendar including event information to the user without the user himself/herself inputting the event information.

With the above configuration, it is possible to achieve a television receiver 4 whose event calendar has much improved user-friendliness compared with before.

### 2. Second Embodiment

Next, a description is given of a second embodiment. Unlike the first embodiment, in the second embodiment, event information is extracted from a broadcast content in accordance with an instruction from a user. Accordingly, here, a description is mainly given of an event-information extraction processing procedure. In this regard, the configuration of the television receiver 4 and the event-calendar display processing procedure are the same as those of the first embodiment, and thus refer to the first embodiment.

### 2.1 Event Information Extraction Processing Procedure

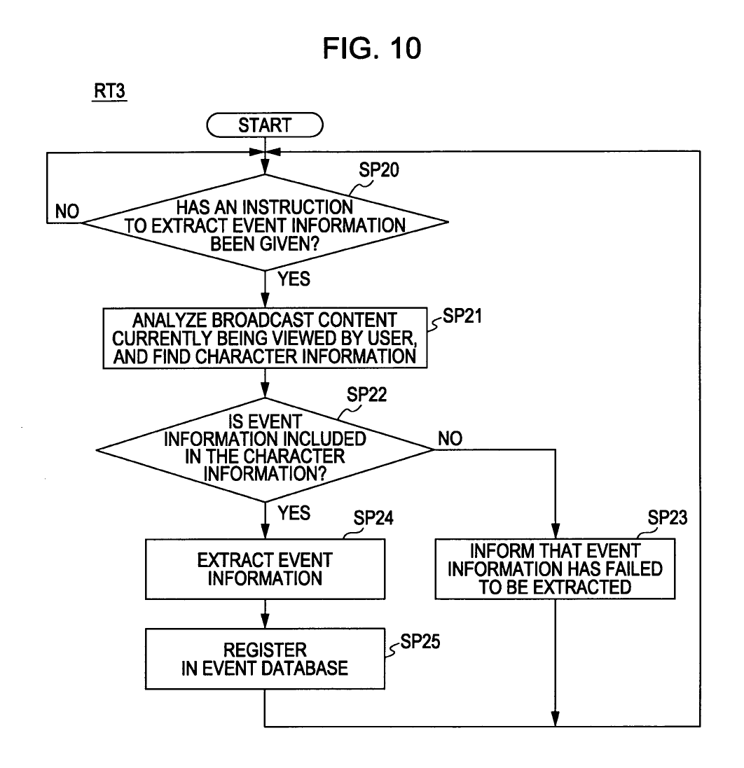

A description will be given of an event-information extraction processing procedure in the second embodiment using a flowchart shown in FIG. 10. Incidentally, the processing procedure is also a processing procedure executed by the CPU 11 of the television receiver 4 in accordance with the program written in the ROM 12 or the HDD 13.

When, for example, the power to the television receiver 4 is turned on, the CPU 11 starts an event-information extraction processing procedure RT3, and the processing proceeds to step SP20. In step SP20, the CPU 11 waits for being instructed to extract event information through the remote controller RM. If instructed to perform extraction, the processing proceeds to step SP21. In this regard, for example, if an event-information extraction key disposed on the remote controller RM is pressed, the CPU 11 determined that an instruction has given to extract event information.

In step SP21, the CPU 11 analyzes a broadcast content (video and sound of the program) currently being viewed by a user, or a broadcast content (program video sound, subtitles, an electronic program guide, data broadcasting, etc.) currently being presented so as to find character information from the broadcast content. After that, the processing of the CPU 11 proceeds to the next step SP22.

In step SP22, the CPU 11 determines whether the found character information includes event information. If the character information does not include event information, and thus negative result is obtained by step SP22, the processing of the CPU 11 proceeds to step SP23. In step SP23, the CPU 11 displays character information indicating that event information has not been found to the display 23 so as to inform the user that event information has not been found. After that, the processing returns to step SP20, and the CPU waits for an instruction to extract event information again.

On the other hand, if the character information includes event information, and thus affirmative result is obtained by step SP22, the processing of the CPU 11 proceeds to step SP24. In step SP24, the CPU 11 extracts event information from the character information, and the processing proceeds to the next step SP25.

In step SP25, the CPU 11 stores the extracted event information in the event database, and the processing returns to step SP20 again, and waits for being instructed to extract event information again.

In accordance with such event information extraction processing procedure RT3, the CPU 11 extracts event information from a broadcast content, and stores the event information in the event database.

In this manner, in the second embodiment, when the television receiver 4 is instructed by the user to extract event information, the television receiver 4 extracts event information from the broadcast content being played back and output at that time.

In this manner, for example, if the user instructs to extract event information when requested event information is displayed on a program video being viewed, the television receiver 4 is allowed to extract the displayed requested event information.

That is to say, the television receiver 4 can extract event information requested by the user from a broadcast content without being provided with a preference database, etc.

### 3. Other Embodiments

3.1 Other embodiment-1

In this regard, in the above-described first and second embodiments, the television receiver 4 extracts event information from a broadcast content, stores the information into the event database, and displays the event calendar screen 30 on the display 23 on the basis of the stored event information.

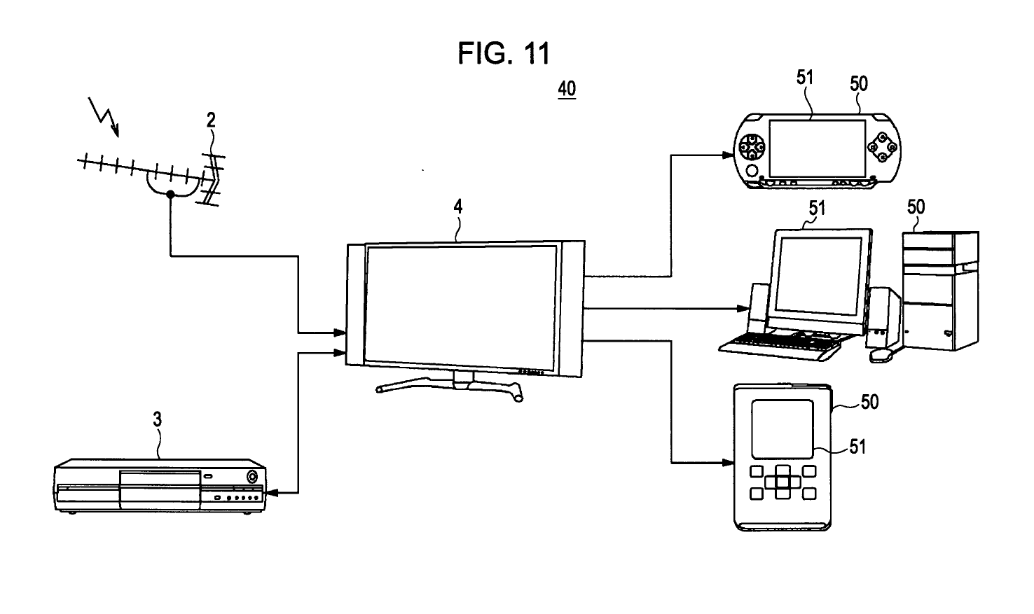

However, the present invention is not limited to this. For example, as an event calendar display system 40 shown in FIG. 11, the television receiver 4 may transmit the event information stored in the event database to the display apparatus 50 in accordance with a request from an external display apparatus 50.

The display apparatus 50 has a function of displaying an event-calendar screen 30, and displays an event-calendar screen 30 on a display 51 on the basis of the event information received from the television receiver 4.

In this manner, even the display apparatus 50 having a simple configuration without a function of receiving a broadcast content and a function of extracting event information, it is possible to display an event-calendar screen 30 by obtaining event information from the television receiver 4.

In this regard, various configurations are considered for the connection configuration of the television receiver 4 and the external display apparatus 50. For example, the television receiver 4 may be connected to the external display apparatus 50 through the external connection interface 25 and the network interface 26 as a transmission section. Also, the television receiver 4 may be provided with an interface other than these, and the television receiver 4 and the external display apparatus 50 may be connected.

### 3.2 Other Embodiment-2

Also, in the above-described first and second embodiments, an event database is built in the HDD 13 of the television receiver 4.

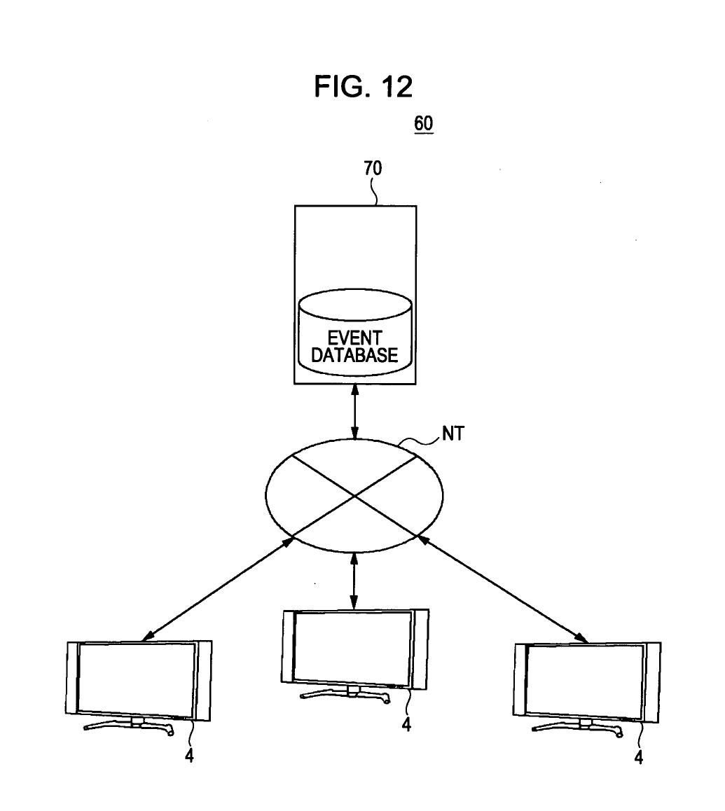

However, the present invention is not limited to this. For example, as an event-calendar display system 60, shown in FIG. 12, the event database may be built in an HDD (not shown in the figure) of the server 70 on a network NT. In this case, the television receiver 4 transmits event information extracted from a broadcast content to the server 70, and stores the information in an event database of the server 70. In this regard, the event information to be transmitted to the server 70 may be all the event information extracted from a broadcast content, or only the event information selected on the basis of the preference keywords.

And the television receiver 4 receives event information stored in the event database of the server 70 from the server 70, and displays the event calendar screen 30 on the basis of the event information.

In this manner, if an event database is built in the server 70 on the network, it is possible to collect event information extracted individually by a plurality of television receivers 4 to the server 70. And by obtaining the event information collected in the server 70, the television receiver 4 can present an event calendar including much more event information to the user.

### 3.3 Other Embodiment-3

Further, in the above-described first and second embodiments, various kinds of information on an event is obtained from a network and displayed in response to the pressing of the connect-to-network button 31B displayed on the event detail window 31.

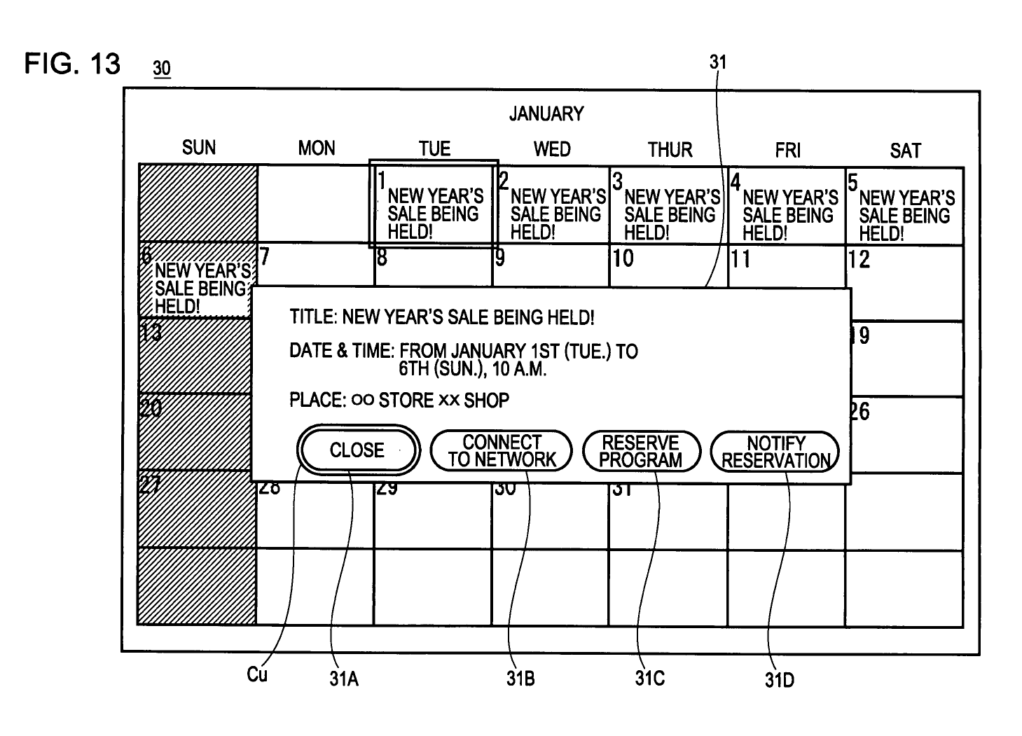

However, the present invention is not limited to this. For example, as shown in FIG. 13, a reserve program button 31C is displayed on the event detail window 31. And the CPU 11 of the television receiver 4 may search EPG data for a program on the event displayed on the event detail window 31 and may automatically reserve (reserve viewing or reserve recording) the program in response to pressing of the reserve program button 31C.

Specifically, for example, the CPU 11 may reserve a program whose program information includes the event title.

Also, only if event information of the event displayed on the event detail window 31 is event information extracted from an electronic program guide, the reserve program button 31C may be displayed on the event detail window 31, etc.

Further, a notify reservation button 31D may be displayed on the event detail window 31, and if the notify reservation button 31D has been pressed, when time comes close to the date and time of the event displayed on the event detail window 31, the user may be notified of that.

That is to say, if the notify reservation button 31D is pressed, the CPU 11 of the television receiver 4 stores the event information (for example, date and time, and a title) of the event displayed on the event detail window 31 in the HDD 13 as notification reservation information.

And the CPU 11 displays, for example, the notification reservation information on the display 23 when it comes to a week before the event date and time included in the notification reservation information, informing the user that the event will be held soon.

In this manner, it is possible for the user who has failed to see the event calendar screen 30 to reliably recognize that the event will be held soon.

### 3.4 Other Embodiment-4

Further, in the above-described first and second embodiments, event information is extracted from video sound of a program, subtitles, an electronic program guide, data broadcast, etc., which are broadcast contents. However, the present invention is not limited to this. If a content might include event information, event information may be extracted from various kinds of contents in addition.

For example, event information may be extracted from an electronic mail, downloaded video sound and still images, video sound and still images recorded on a recording medium, etc.

### 3.5 Other Embodiment-5

Further, in the above-described first and second embodiments, event date and time, an event title, a place, a telephone number, a URL, etc., are searched from the character information found from a broadcast content on the basis of dictionary data, and are extracted as event information.

However, the present invention is not limited to this. Event information may be extracted from character information by the other various extraction methods.

For example, a plurality of patterns of rules for identifying event information may be provided in advance. Event information may be extracted using the patterns. Incidentally, a rule in this case is that, for example, “event information as program advertisement information includes event date and time in a first row, an event title in the second row, a place in the third row, and a telephone number in the fourth row”.

### 3.6 Other Embodiment-6

Further, in the above-described first and second embodiments, event date and time, an event title, a place, a telephone number, a URL, etc., are extracted as event information from a broadcast content.

However, the present invention is not limited to this. When, for example, the CPU 11 of the television receiver 4 extracts event information from a program video, the video processing section 22 may capture a still image of the video, and may record this in the HDD 13 as a thumbnail of the event information.

And the CPU 11 displays the thumbnail in a box of the event calendar screen 30 together with the event title.

In this manner, if a thumbnail of an event is displayed in addition to an event title, it is possible for the user to more easily check what event is to be held.

Also, as long as being displayed in a box, not only an event title and a thumbnail, but also other information included in event information may be displayed.

### 3.7 Other Embodiment-7

Further, in the above-described first embodiment, the television receiver 4 automatically stores preference keywords indicating a user's preference into a preference database on the basis of a program viewing history and operation histories at various screens.

However, the present invention is not limited to this. The user may input or select preference keywords, and may store the preference keywords into a preference database. Also, as preference keywords, the keywords the user likes and the keywords the user dislikes may be stored. The event information including the keywords the user likes may be positively selected, and the keywords the user dislikes may not be selected as much as possible, or the like.

### 3.8 Other Embodiment-8

Further, in the above-described first and second embodiments, the program for performing event extraction processing and event-calendar display processing of the television receiver 4 is written in the ROM 12 or the HDD 13 of the television receiver 4.

However, the present invention is not limited to this. The program may be recorded in a recording medium, such as a CD (Compact Disc), a DVD (Digital Versatile Disc), a memory card, etc. And the CPU 11 of the television receiver 4 may read the program from the recording medium, and execute the program. Also, the program read from the recording medium may be installed in the HDD 13.

Further, the program may be downloaded from a predetermined server on a network, and may be installed in the HDD 13. In this regard, in order to read the program from a recording medium, a drive of the recording medium may be built in the television receiver 4, or the television receiver 4 may be connected to the drive through an external connection interface 25.

### 3.9 Other Embodiment-9

Further, in the above-described embodiments, the television receiver 4, as an event-calendar display apparatus and an event-information extraction apparatus, is provided with the tuner 15 as a content acquisition section. Also, the television receiver 4 is provided with the CPU 11 as the event-information extraction section, the storage control section, and the display control section. Further, the television receiver 4 is provided with the audio processing section 20 and the video processing section 22 as the event-information extraction section and the playback and output section. Further, the television receiver 4 is provided with the audio decoder 18, the video decoder 19, the speaker 21, the display 23, and the graphics controller 24 as the playback and output section. Further, the television receiver 4 is provided with the external connection interface 25, the network interface 26 as the transmission section. Further, the television receiver 4 is provided with the HDD 13 as the storage section and the display 23 as the display section.

However, the present invention is not limited to this. Individual functional sections of the above-described television receiver 4 may be constituted by the other various kinds of hardware or software as long as having the same functions.

Also, the present invention may be applied not only to the television receiver 4, but also to the other various kinds of apparatuses, such as a PC (Personal Computer), a cellular phone, etc., as long as an event-calendar display apparatus and an event-information extraction apparatus have the same functions.

### 3.10 Other Embodiment-10

Moreover, the present invention is not limited to the above-described first and second embodiments and the other embodiments 1 to 9 described so far. That is to say, the present invention covers a part of or all of any combinations of the above-described first and second embodiments and the other embodiments 1 to 9, or a partial extraction of the embodiments.

For example, a combination of the first embodiment and the second embodiment may be made. In this case, the television receiver 4 may be provided with a mode of automatically extracting event information and a mode of manually extracting. And the television receiver 4 extracts event information in the procedure described in the first embodiment if the user selects the automatically extracting mode. On the other hand, the television receiver 4 extracts event information in the procedure described in the second embodiment if the user selects the manually extracting mode. In this manner, it is possible to further improve the user-friendliness of the event calendar.

Also, for example, the other embodiment 2 and the other embodiment 7 may be combined. In this case, the television receiver 4 sends the preference keywords having been input by the user and a transmission request of the event information to the server 50. The server 50 selects only the event information including the transmitted preference keywords out of the event information stored in the event database, and transmits the information to the television receiver 4.

In this manner, even if event information is stored in the event database of the server 50, each television receiver 4 can present only an event calendar including the event information matching the user's preference to the user.

It should be understood by those skilled in the art that various modifications, combinations, sub-combinations and alterations may occur depending on design requirements and other factors insofar as they are within the scope of the appended claims or the equivalents thereof.

What is claimed is:

1. An event-calendar display apparatus comprising:
a content acquisition section acquiring a television program;
an event-information extraction section analyzing the television program acquired by the content acquisition section and extracting event information from the television program;
a storage control section storing the event information extracted by the event-information extraction section into a storage section; and
a display control section displaying the event information stored in the storage section on a display section in a calendar format.

2. The event-calendar display apparatus according to claim 1, further comprising a playback and output section outputting the television program,
wherein the event-information extraction section extracts event information from a television program being played back and output by the playback and output section.

3. The event-calendar display apparatus according to claim 2,
wherein the event-information extraction section extracts event information from a television program being played back and output at a point in time when an instruction is given to extract event information through an operation section.

4. The event-calendar display apparatus according to claim 1,
wherein the event-information extraction section finds character information from the television program, and extracts the event information from the character information.

5. The event-calendar display apparatus according to claim 1,
wherein the storage control section stores only event information matching a user's preference from the event information out of the event information extracted by the event-information extraction section.

6. A method of displaying an event calendar, the method comprising the steps of:
acquiring a television program;
analyzing the television program;
extracting event information from the television program;
storing the event information into a storage section; and
displaying the event information stored in the storage section on a display section in a calendar format.

7. An event-calendar display program causing a computer to perform processing comprising the steps of:
acquiring a television program;
analyzing the television program;
extracting event information from the television program;
storing the extracted event information into a storage section; and
displaying the event information stored in the storage section on a display section in a calendar format.

8. An event information extraction apparatus comprising:
a content acquisition section acquiring a television program;
an event-information extraction section analyzing the television program acquired by the content acquisition section and extracting event information from the television program;
a storage control section storing the event information extracted by the event-information extraction section into a storage section; and
a transmission section transmitting the event information stored in the storage section to a display apparatus displaying in a calendar format.
